(19) United States
(12) Patent Application Publication
(10) Pub. No.: US 2021/0329735 A1
(43) Pub. Date: Oct. 21, 2021

(54) COMMUNICATION APPARATUS AND WIRELESS COMMUNICATION SYSTEM

(71) Applicant: CIRCLEONE CO., LTD., Beppu-shi (JP)

(72) Inventor: Toshio ICHIMARU, Beppu-shi (JP)

(21) Appl. No.: 16/493,279

(22) PCT Filed: Apr. 22, 2019
(86) PCT No.: PCT/JP2019/017099

§ 371 Date: Sep. 11, 2019

(30) Foreign Application Priority Data
Jun. 18, 2018 (JP) 2018-115205

(51) Int. Cl. H04W 76/45; H04B 1/50; H04M 3/56; H04W 4/10

(52) U.S. Cl. CPC H04W 76/45; H04W 4/10; H04M 3/56; H04B 1/50

(57) ABSTRACT

A communication apparatus and a wireless communication system are provided to perform information transmission between a first communication device group and a second communication device group via wireless communication performed by means of radio waves of mutually different frequencies without being limited by frequency allocation. The communication apparatus includes a first voice input means for inputting a voice emitted from a first communication device that is one constituent element of the first communication device group into a second communication device that is one constituent element of the second communication device group and a second voice input means for inputting another voice emitted from the second communication device that is one constituent element of the second communication device group into the first communication device that is one constituent element of the first communication device group.

### TECHNICAL FIELD

The present invention relates to a communication apparatus and a wireless communication system that are capable of performing communication between communication devices between which wireless communication is performed by means of radio waves of mutually different frequencies in a simple and easy way.

### BACKGROUND ART

Wireless communication is widely used in a disaster-prevention wireless system and so forth, and various types exist as a wireless communication device. However, in ordinary wireless communication, users are licensed according to the Radio Law, and frequencies to be used are allocated to the users. Therefore, limitations caused by frequency allocation are imposed on the users, thus making it difficult to perform communication between communication devices that employ radio waves of different frequencies.

Patent Literature 1 discloses a power-line carrier communication system that is capable of performing communication between a plurality of power-line carrier communication apparatuses using mutually different carrier frequencies even when communications are made to the communication apparatuses by use of the different carrier frequencies in accordance with frequency characteristics of power lines. In this system, a frequency mutual-conversion device is disposed between one of the power-line carrier communication apparatuses and the other power-line carrier communication apparatus that are performing communication, which can be established by converting signals of carrier frequencies, and therefore the frequency mutual-conversion device is required.

Patent Literature 1: Japanese UnexaminedPatent

Application Publication No. H11-127092

### SUMMARY OF INVENTION

### Technical Problem

In wireless communication, it is possible to likewise perform communication between communication devices for wireless communication by means of radio waves of different frequencies while using the aforementioned frequency mutual-conversion device, and yet the use of the frequency mutual-conversion device makes a device configuration complex, and makes the wide applicability of the communication system difficult. Additionally, in communication devices between which wireless communication is performed by means of radio waves of different frequencies, how to properly perform bidirectional communication is also an important problem to be solved.

The present invention has been made in consideration of these circumstances, and aims to provide a communication apparatus and a wireless communication system that are capable of performing communication between communication devices between which wireless communication is performed by means of radio waves of mutually different frequencies in a simple and easy way and that are capable of performing communication without being limited by frequency allocation.

### Solution to Problem

To solve the aforementioned problem, the communication apparatus of the present invention is a communication apparatus that performs information transmission between a first communication device group and a second communication device group between which wireless communication is performed by means of radio waves of mutually different frequencies, and the communication apparatus includes a voice input means for inputting a voice emitted from a communication device that is one constituent element of the first communication device group into a communication device that is one constituent element of the second communication device group and a voice input means for inputting a voice emitted from a communication device that is one constituent element of the second communication device group into a communication device that is one constituent element of the first communication device group, and the voice input means allows a voice emitted from a voice/reception output terminal of one communication device to be input into a microphone input terminal of one other communication device, and allows a signal emitted from a voice/reception output terminal of one communication device to be input into a PTT contact signal converter, and, as a result, a PTT button signal of one other communication device comes into an ON state, and the communication apparatus further includes a controller that determines whether a voice has been emitted from a communication device that is one constituent element of the first communication device group or from a communication device that is one constituent element of the second communication device group, and the controller brings a PTT button signal of the communication device that is one constituent element of the second communication device group into an ON state through a first PTT contact signal converter and transmits a voice to the communication device that is one constituent element of the second communication device group if the controller determines that the voice has been emitted from the communication device that is one constituent element of the first communication device group, and the controller brings a PTT button signal of the communication device that is one constituent element of the first communication device group into an ON state through a second PTT contact signal converter and transmits a voice to the communication device that is one constituent element of the first communication device group if the controller determines that the voice has been emitted from the communication device that is one constituent element of the second communication device group, and the communication apparatus further includes a selector switch, and, based on a determination made by the controller, the selector switch performs switching between the voice input means for inputting a voice emitted from a communication device that is one constituent element of the first communication device group into a communication device that is one constituent element of the second communication device group and the voice input means for inputting a voice emitted from a communication device that is one constituent element of the second communication device group into a communication device that is one constituent element of the first communication device group.

The voice input means allows information transmission to be performed between the first communication device group and the second communication device group between which wireless communication is performed by means of radio waves of mutually different frequencies, and therefore it becomes possible to perform communication between communication devices between which wireless communication is performed by means of radio waves of different frequencies in a simple and easy way without disposing a frequency mutual-conversion device. Therefore, it is possible to perform communication without being limited by frequency allocation.

In the communication apparatus of the present invention, the voice input means allows a voice emitted from a voice/reception output terminal of one communication device to be input into a microphone input terminal of one other communication device, and allows a signal emitted from a voice/reception output terminal of one communication device to be input into a PTT contact signal converter, and, as a result, it is possible to bring a PTT button signal of one other communication device into an ON state. (“PTT” is an abbreviation of “Press to Talk” or “Push to Talk.” The same applies hereinafter.)

The provision of the thus formed voice input means makes it possible to accurately grasp timing at which a voice signal is transmitted from one communication device to one other communication device in a state in which these communication devices employ radio waves of mutually different frequencies.

The communication apparatus of the present invention includes a controller that determines whether a voice has been emitted from a communication device that is one constituent element of the first communication device group or from a communication device that is one constituent element of the second communication device group, and the controller is capable of bringing a PTT button signal of the communication device that is one constituent element of the second communication device group into an ON state through a first PTT contact signal converter and transmitting a voice to the communication device that is one constituent element of the second communication device group if the controller determines that the voice has been emitted from the communication device that is one constituent element of the first communication device group, and the controller is capable of bringing a PTT button signal of the communication device that is one constituent element of the first communication device group into an ON state through a second PTT contact signal converter and transmitting a voice to the communication device that is one constituent element of the first communication device group if the controller determines that the voice has been emitted from the communication device that is one constituent element of the second communication device group.

Although it is necessary to understand the type of a communication device from which a voice is flowing in order to perform bidirectional communication between communication devices that employ radio waves of mutually different frequencies, the provision of the thus formed controller makes it possible to accurately fix the direction of communication between communication devices that employ radio waves of mutually different frequencies, and makes it possible to properly perform bidirectional communication between different types of communication devices.

The communication apparatus of the present invention can include a selector switch, and, based on a determination made by the controller, the selector switch performs switching between a voice input means for inputting a voice emitted from a communication device that is one constituent element of the first communication device group into a communication device that is one constituent element of the second communication device group and a voice input means for inputting a voice emitted from a communication device that is one constituent element of the second communication device group into a communication device that is one constituent element of the first communication device group.

The switching operation of a switch that is a constituent element of the selector switch makes it possible to perform switching between those voice input means, and therefore it is possible to switch from one direction to one other direction of communication between communication devices that employ radio waves of mutually different frequencies in a simple and easy way.

The wireless communication system of the present invention is characterized by including the aforementioned communication apparatus of the present invention, and is characterized in that wireless communication is performed between a first communication device group and a second communication device group between which wireless communication is performed by means of radio waves of mutually different frequencies.

Information transmission between a first communication device group and a second communication device group between which wireless communication is performed by means of radio waves of mutually different frequencies is performed by the voice input means, and therefore it becomes possible to perform communication between communication devices between which wireless communication is performed by means of radio waves of different frequencies in a simple and easy way without disposing a frequency mutual-conversion device. Therefore, it is possible to perform communication without being limited by frequency allocation. Advantageous Effects of Invention

According to the present invention, it becomes possible to perform communication between communication devices between which wireless communication is performed by means of radio waves of different frequencies in a simple and easy way. Therefore, it is possible to perform communication without being limited by frequency allocation.

### BRIEF DESCRIPTION OF DRAWINGS

FIG. 1 is a view showing a configuration of a communication apparatus and a wireless communication system according to an embodiment of the present invention.

FIG. 2 is a view showing a configuration of a communication apparatus and a wireless communication system according to an embodiment of the present invention.

FIG. 3 is a view showing a function of a controller that determines whether a voice has been emitted from a communication device that is one constituent element of a first communication device group or from a communication device that is one constituent element of a second communication device group.

FIG. 4 is a view showing a configuration of a communication apparatus and a wireless communication system that clearly shows a situation of bidirectional communication.

### DESCRIPTION OF EMBODIMENTS

A communication apparatus and a wireless communication system of the present invention will be hereinafter described on the basis of its embodiments.

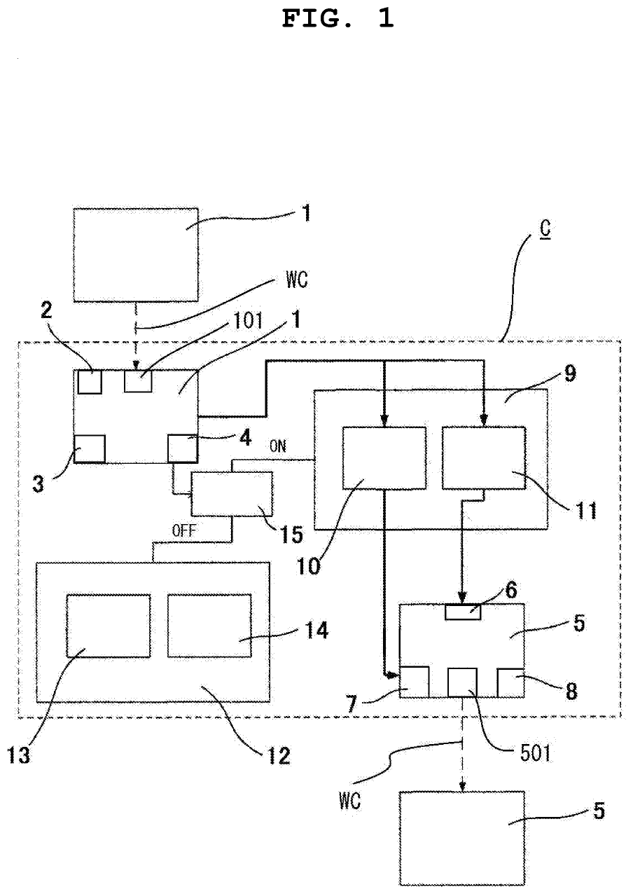

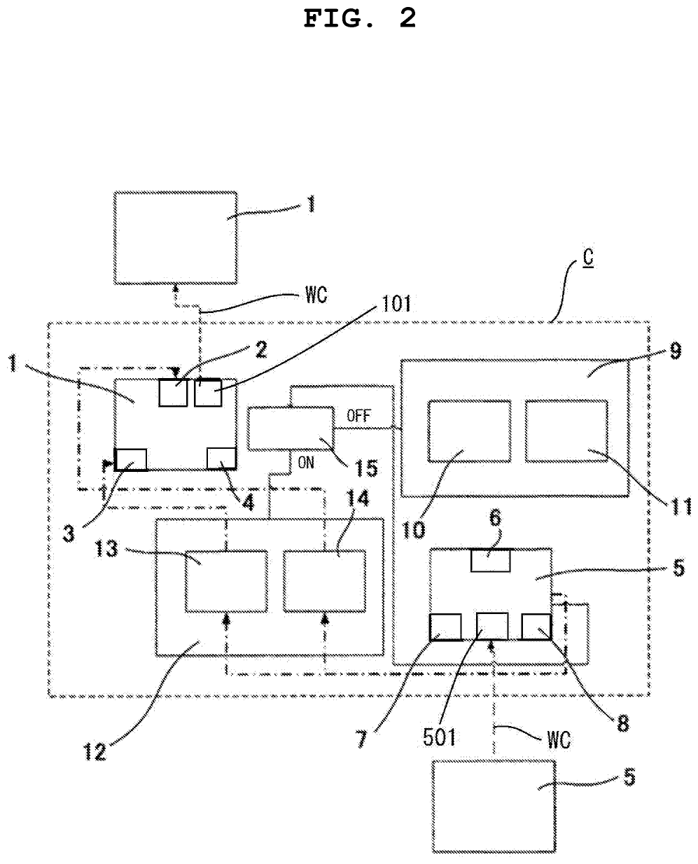

FIG. 1 and FIG. 2 each show a configuration of a communication apparatus and a wireless communication system according to an embodiment of the present invention.

FIG. 1 shows a situation of information transmission from a first communication device group to a second communication device group which are performing wireless communication with each other by means of radio waves of mutually different frequencies.

In FIG. 1, a communication device A type 1 is a communication device that belongs to the first communication device group that performs wireless communication by use of a radio wave of a specific frequency, and the communication device A type 1 is composed of an antenna 101 that transmits/receives radio waves, a PTT button 2, a microphone input terminal 3, and a voice/reception output terminal 4.

A communication device B type 5 is a communication device that belongs to the second communication device group that performs wireless communication by use of a radio wave of a frequency differing from that of the communication device A type 1, and the communication device B type 5 is composed of an antenna 501 that transmits/receives radio waves, a PTT button 6, a microphone input terminal 7, and a voice/reception output terminal 8. Each of the voice/reception output terminals 4 and 8 outputs a voice, and outputs a reception state as a signal in the form of a reception lamp or a reception signal.

A voice conversion device 9 is composed of a microphone signal converter 10 and a PTT contact signal converter 11. Additionally, a voice conversion device 12 is composed of a microphone signal converter 13 and a PTT contact signal converter 14. A selector switch 15 is connected to the voice conversion device 9 and to the voice conversion device 12. In FIG. 1, the voice conversion device 9 into which a signal emitted from the communication device A type 1 is input is brought into an ON state by the switching operation of the selector switch 15, whereas the voice conversion device 12 into which a signal emitted from the communication device B type 5 is input is brought into an OFF state by the switching operation of the selector switch 15.

The PTT contact signal converters 11 and 14 can be each formed of a VOX circuit (which is an abbreviation of “Voice Operation Control.” The same applies hereinafter.), and, when a voice signal emitted from the voice/reception output terminal of one of the communication devices is input into the VOX circuit, a PTT button signal of the other communication device is brought into an ON state. Hence, it becomes possible to perform communication with the other communication device that differs in frequency. Additionally, the PTT contact signal converters 11 and 14 can be each configured so that a PTT button signal of one of the communication devices is brought into an ON state by inputting a light signal, which is lit by the emission of a voice from the voice/reception output terminal of the other communication device, into an optical switch.

In the following concrete example, a description of a case in which voice signals are input into the PTT contact signal converters 11 and 14 is given on the assumption that the PTT contact signal converters 11 and 14 are each formed of a VOX circuit, and yet the PTT contact signal converters 11 and 14 are not limited to this, and another mode may be employed if a reception state is output from the voice/reception output terminal of one of the communication devices as a signal in the form of a reception lamp or a reception signal, and, as a result, a PTT button signal of the other communication device is brought into an ON state.

The communication device A types 1 perform wireless communication with each other by means of a radio wave of a frequency used in the first communication device group, and a voice emitted from the voice/reception output terminal 4 of the communication device A type 1 is input into the microphone input terminal 7 of the communication device B type 5 through the microphone signal converter 10 disposed in the voice conversion device 9. The microphone signal converter 10 adjusts a voice signal so as to reach a signal level and an impedance that are suitable for microphone input.

Additionally, when a voice is input into the microphone input terminal 7, a voice signal of the communication device A type 1 is input into the PTT contact signal converter 11, and, as a result, a PTT button signal of the communication device B type 5 is brought into an ON state.

As thus described, the voice conversion device 9 functions as a communication apparatus that performs information transmission while making signal conversion between the first and second communication device groups between which wireless communication is performed by means of radio waves of mutually different frequencies.

The aforementioned operation of the voice conversion device 9 makes it possible to make a call from the communication device A type 1 to the communication device B type 5 which are performing wireless communication with each other by means of radio waves of mutually different frequencies, without making frequency conversion. Information that has been transmitted to the communication device B type 5 is exchanged between the communication device B types 5 in the form of wireless communication by means of a radio wave of a frequency used in the second communication device group. In this way, it becomes possible to perform wireless communication that has overcome the barrier of frequency allocation.

FIG. 2 shows a situation in which, conversely to that of FIG. 1, information is transmitted from the second communication device group to the first communication device group which are performing wireless communication with each other by means of radio waves of mutually different frequencies.

In FIG. 2, the communication device B type 5 is a communication device that belongs to the second communication device group that performs wireless communication by use of a radio wave of a specific frequency, and the communication device B type 5 is composed of the antenna 501 that transmits/receives radio waves, the PTT button 6, the microphone input terminal 7, and the voice/reception output terminal 8.

The communication device A type 1 is a communication device that belongs to the first communication device group that performs wireless communication by use of a radio wave of a frequency differing from that of the communication device B type 5, and the communication device A type 1 is composed of the antenna 101 that transmits/receives radio waves, the PTT button 2, the microphone input terminal 3, and the voice/reception output terminal 4.

The voice conversion device 9 is composed of the microphone signal converter 10 and the PTT contact signal converter 11. Additionally, the voice conversion device 12 is composed of the microphone signal converter 13 and the PTT contact signal converter 14. The selector switch 15 is connected to the voice conversion device 9 and to the voice conversion device 12. In FIG. 2, the voice conversion device 9 into which a signal emitted from the communication device A type 1 is input is brought into an OFF state by the switching operation of the selector switch 15, whereas the voice conversion device 12 into which a signal emitted from the communication device B type 5 is input is brought into an ON state by the switching operation of the selector switch 15.

The communication device B types 5 perform wireless communication with each other by means of a radio wave of a frequency used in the second communication device group, and a voice emitted from the voice/reception output terminal 8 of the communication device B type 5 is input into the microphone input terminal 3 of the communication device A type 1 through the microphone signal converter 13 disposed in the voice conversion device 12. The microphone signal converter 13 adjusts a voice signal so as to reach an impedance of a signal level that is suitable for microphone input.

Additionally, when a voice is input into the microphone input terminal 3, a voice signal of the communication device B type 5 is input into the PTT contact signal converter 14, and, as a result, a PTT button signal of the communication device A type 1 is brought into an ON state.

As thus described, the voice conversion device 12 functions as a communication apparatus that performs information transmission while making signal conversion between the first and second communication device groups between which wireless communication is performed by means of radio waves of mutually different frequencies.

The aforementioned operation of the voice conversion device 12 makes it possible to make a call from the communication device B type 5 to the communication device A type 1 which are performing wireless communication with each other by means of radio waves of mutually different frequencies, without making frequency conversion. Information that has been transmitted to the communication device A type 1 is exchanged between the communication device A types 1 in the form of wireless communication by means of a radio wave of a frequency used in the first communication device group. In this way, it becomes possible to perform wireless communication that has overcome the barrier of frequency allocation.

As thus described, the communication apparatus of the present invention is a communication apparatus that performs information transmission between first and second communication device groups between which wireless communication is performed by means of radio waves of mutually different frequencies, and the communication apparatus has a voice input means that inputs a voice emitted from a communication device that is one constituent element of a first communication device group into a communication device that is one constituent element of a second communication device group, and has a voice input means that inputs a voice emitted from a communication device that is one constituent element of the second communication device group into a communication device that is one constituent element of the first communication device group.

In the voice input means, a voice emitted from a voice/reception output terminal of one of the communication devices is input into a microphone input terminal of the other communication device, and a voice signal of one of the communication devices is input into a PTT contact signal converter, and, as a result, a PTT button signal of the other communication device is brought into an ON state.

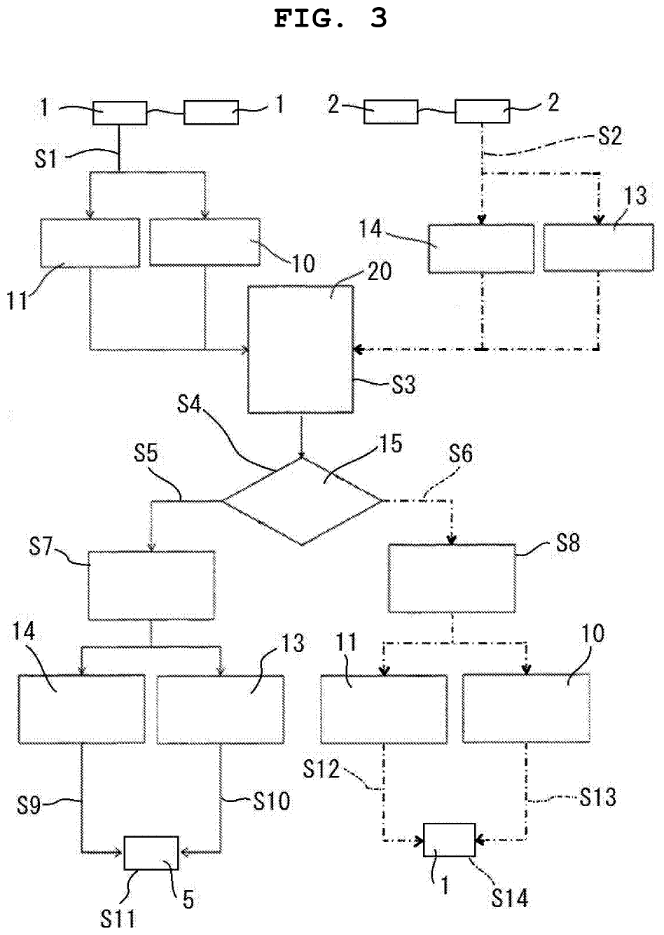

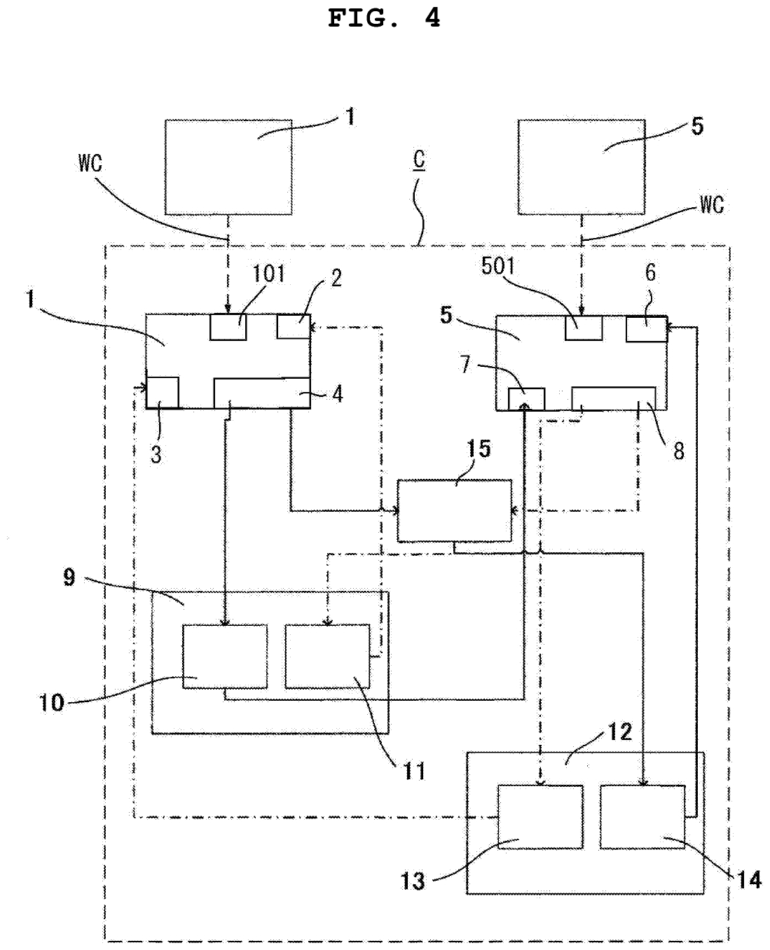

In order to perform bidirectional communication between communication devices that employ radio waves of mutually different frequencies, it is necessary to understand the type of a communication device from which a voice is flowing, and FIG. 3 shows a function of a controller that determines whether a voice has been emitted from a communication device that is one constituent element of the first communication device group or from a communication device that is one constituent element of the second communication device group. Additionally, FIG. 4 shows a configuration of a communication apparatus and a wireless communication system that clearly shows a situation of bidirectional communication.

Operations or steps with respect to the controller are shown by reference signs S1 to S14 in FIG. 3. In detail, S1 represents “Voice output and reception signal output,” S2 represents “Voice output and reception signal output,” S3 represents “Controller has CPU, and a voice signal and a reception state signal are received and transferred to a different type of communication device,” S4 represents “CPU is conversion-device selector switch, which discriminates between signals and voices that have been emitted from the PTT signal converter,” S5 represents “Case of a voice emitted from the communication device A,” S6 represents “Case of a voice emitted from the communication device B,” S7 represents “A voice signal and a reception signal that have been emitted from the communication device A,” S8 represents “A voice signal and a reception signal that have been emitted from the communication device B,” S9 represents “To PTT input,” S10 represents “To microphone input,” S11 represents “A voice of the communication device A,” S12 represents “To PTT input,”S13 represents “To microphone input,” and S14 represents “A voice of the communication device B.”

Wireless communication is performed between the communication device A types 1 that are constituent elements of the first communication device group, and wireless communication is performed between the communication device B types 5 that are constituent elements of the second communication device group. The controller 20 has a function (for example, a CPU (Central Processing Unit)) to determine whether voice output and reception signal output emitted from the communication device A type 1 are being input into the microphone signal converter 10 and into the PTT contact signal converter 11 or whether voice output and reception signal output emitted from the communication device B type 5 are being input into the microphone signal converter 13 and into the PTT contact signal converter 14.

If the controller 20 determines that the voice output and the reception signal output emitted from the communication device A type 1 that is one constituent element of the first communication device group are being input into the microphone signal converter 10 and into the PTT contact signal converter 11, the selector switch 15 performs a switching operation, and, as a result, the voice signal emitted from the communication device A type 1 brings the PTT button signal of the communication device B type 5 that is one constituent element of the second communication device group into an ON state through a first PTT contact signal converter, i.e., through a PTT contact signal converter to the communication device B type 5, and transmits a voice to the communication device B type 5 that is one constituent element of the second communication device group. As a result, a voice is transmitted from the communication device A type 1 to the communication device B type 5.

This communication state is shown by the solid line in FIG. 3 and FIG. 4. At this time, the voice conversion device 9 into which the voice of the communication device A type 1 is input comes into an ON state, whereas the voice conversion device 12 into which the voice of the communication device B type 5 is input comes into an OFF state as shown in FIG. 1.

Conversely, if the controller 20 determines that the voice output and the reception signal output emitted from the communication device B type 5 that is one constituent element of the second communication device group are being input into the microphone signal converter 13 and into the PTT contact signal converter 14, the selector switch 15 performs a switching operation, and, as a result, the voice signal emitted from the communication device B type 5 brings the PTT button signal of the communication device A type 1 that is one constituent element of the first communication device group into an ON state through a second PTT contact signal converter, i.e., through a PTT contact signal converter to the communication device A type 1, and transmits a voice to the communication device A type 1 that is one constituent element of the first communication device group. As a result, a voice is transmitted from the communication device B type 5 to the communication device A type 1.

This communication state is shown by the alternate long and short dash line in FIG. 3 and FIG. 4. At this time, the voice conversion device 9 into which the voice of the communication device A type 1 is input comes into an OFF state, whereas the voice conversion device 12 into which the voice of the communication device B type 5 is input comes into an ON state as shown in FIG. 2.

As thus described, the controller 20 has a function to determine whether a voice has been emitted from a communication device that is one constituent element of the first communication device group or from a communication device that is one constituent element of the second communication device group, and, if the controller 20 determines that a voice has been emitted from the communication device that is one constituent element of the first communication device group, a voice signal is sent to the first PTT contact signal converter to bring the PTT button signal of the communication device that is one constituent element of the second communication device group into an ON state, and a voice is transmitted to the communication device that is one constituent element of the second communication device group.

On the other hand, if the controller 20 determines that a voice has been emitted from the communication device that is one constituent element of the second communication device group, a voice signal is sent to the second PTT contact signal converter to bring the PTT button signal of the communication device that is one constituent element of the first communication device group into an ON state, and a voice is transmitted to the communication device that is one constituent element of the first communication device group.

Based on this determination of the controller 20, the on/off switching operation of a switch that is a constituent element of the selector switch 15 is performed, and hence switching is performed between a voice input means that inputs a voice emitted from the communication device that is one constituent element of the first communication device group into the communication device that is one constituent element of the second communication device group and a voice input means that inputs a voice emitted from the communication device that is one constituent element of the second communication device group into the communication device that is one constituent element of the first communication device group.

The provision of the thus formed controller 20 makes it possible to accurately fix the direction of communication between communication devices that employ radio waves of mutually different frequencies, and makes it possible to properly perform bidirectional communication between different types of communication devices.

The provision of the aforementioned communication apparatus makes it possible to establish a wireless communication system that performs wireless communication between first and second communication device groups between which wireless communication is performed by means of radio waves of mutually different frequencies.

Although communication between the first and second communication device groups, i.e., between the two types of communication devices that differ in frequency to be used has been described as above, two or more communication device groups may be provided, and bidirectional communication can be performed between a plurality of communication device groups in accordance with the aforementioned configuration and the aforementioned operation principle.

When wireless communication is applied to disaster prevention, a license is given to a user under the Radio Law, and frequencies to be used are allocated, and therefore calls cannot be made between authorized personnel of a police station, a fire station, and an autonomous body that are organizations involved in disaster prevention, and relevant organizations cannot transmit information to each other by means of wireless communication, and yet the employment of the wireless communication system of the present invention greatly contributes to the spread of a disaster prevention wireless system without limitations imposed by frequency allocation.

### INDUSTRIAL APPLICABILITY

The present invention is widely usable as a communication apparatus and a wireless communication system that are capable of performing communication between communication devices between which wireless communication is performed by means of radio waves of different frequencies in a simple and easy way and that are capable of performing communication without being limited by frequency allocation.

### REFERENCE SIGNS LIST

1 Communication device A type

101 Antenna

2 PTT button

3 Microphone input terminal

4 Voice/reception output terminal

5 Communication device B type

501 Antenna

6 PTT button

7 Microphone input terminal

8 Voice/reception output terminal

9 Voice conversion device

10 Microphone signal converter

11 PTT contact signal converter

12 Voice conversion device

13 Microphone signal converter (AF level/impedance converter)

14 PTT contact signal converter

15 Selector switch

20 Controller

C Converter

WC Wireless communication

S1 Voice output and reception signal output

S2 Voice output and reception signal output

S3 Controller has CPU, and voice signal and reception state signal are received and transferred to different type of communication device

S4 CPU is conversion-device selector switch, which discriminates between signals and voices that have been emitted from PTT signal converter

S5 Case of voice emitted from communication device A

S6 Case of voice emitted from communication device B

S7 Voice signal and reception signal that have been emitted from communication device A

S8 Voice signal and reception signal that have been emitted from communication device B

S9 To PTT input

S10 To microphone input

S11 Voice of communication device A

S12 To PTT input

S13 To microphone input

S14 Voice of communication device B

1. A communication apparatus that performs information transmission between a first communication device group and a second communication device group via wireless communication performed by radio waves of mutually different frequencies, the communication apparatus comprising:
a voice input means for inputting a voice emitted from a voice/reception output terminal of the first communication device group into a microphone input terminal a of the second communication device group;
another voice input means for inputting a voice emitted from a voice/reception output terminal of the second communication device group into a microphone input terminal of the first communication device group;
a controller; and
a selector switch,
wherein the voice input means produces a signal emitted from the voice/reception output terminal of the first communication device group to be inputted into a PTT contact signal converter such that a PTT button signal of the second communication device group comes into an ON state,
wherein the other voice input means produces a signal emitted from the voice/reception output terminal of the second communication device group to be inputted into a PTT contact signal converter of the second communication device group such that a PTT button signal of the first communication device group comes into an ON state, and
wherein the controller determines whether the voice has been emitted from the first communication device group or whether the voice has been emitted from the second communication device group,
wherein if the controller determines that the voice has been emitted from the first communication device group, the controller brings the PTT button signal of the communication device of the second communication device group into an ON state through a first PTT contact signal converter and the controller transmits the voice to the second communication device group, and, if the controller determines that the voice has been emitted from the second communication device group, the controller brings the PTT button signal of the first communication device group into an ON state through a second PTT contact signal converter and transmits the voice to of the first communication device group, and
wherein, based on a determination made by the controller, the selector switch performs switching between the voice input means for inputting a voice emitted from the first communication device group into the second communication device group and the other voice input means for inputting the voice emitted from a the second communication device group into the first communication device group.

2. A wireless communication system comprising the communication apparatus according to claim 1, wherein wireless communication is performed between the first communication device group and the second communication device group is performed by radio waves of mutually different frequencies.
